(19) United States
(12) Patent Application Publication
(10) Pub. No.: US 2011/0248974 A1
(43) Pub. Date: Oct. 13, 2011

(54) BACKLIGHT DRIVE DEVICE AND DISPLAY DEVICE HAVING SAME

(75) Inventors: Takayuki Murai, Osaka (JP); Kohji Fujiwara, Osaka (JP)

(73) Assignee: Sharp Kabushiki Kaisha, Osaka-shi, Osaka (JP)

(21) Appl. No.: 12/998,924

(22) PCT Filed: Jan. 29, 2010
(86) PCT No.: PCT/JP2010/051207

§ 371 Date: Jun. 16, 2011

(30) Foreign Application Priority Data
May 29, 2009 (JP) 2009-129928

(51) Int. Cl. G09G 5/10; H05B 37/02

(52) U.S. Cl. 345/207; 315/152

(57) ABSTRACT

Backlight drive units included in a backlight drive device of at least one embodiment of the present invention each have a plurality of metal pads functioning as a plurality of address setting terminals. To provide a potential for setting a unique address by coming into contact with the metal pads, metal protrusions are provided at corresponding locations of a backlight housing. A backlight drive control unit is directly connected to each unit through an IIC bus by a bus scheme and receives, via the IIC bus, a detected amount of light and temperature from each unit identified by the address. With such a simple configuration, a unique address can be automatically set for each unit, obtaining the commonization of backlight drive units.

### TECHNICAL FIELD

The present invention relates, for example, to a backlight drive device that drives a backlight illuminating a liquid crystal panel from the back and a display device having the backlight drive device, and more particularly to a backlight drive device having the function of controlling the luminances of a plurality of backlights (backlight dimming function) and a display device having the backlight drive device.

### BACKGROUND ART

In recent years, an increase in the size of display devices having a backlight such as liquid crystal display devices has been taking place. In many cases, display devices increased in size have a plurality of backlights to illuminate a wide display area.

A plurality of backlights included in such display devices need to uniformly illuminate the display area and thus require control therefor. Accordingly, such display devices have a drive control unit for individually controlling the luminances of the respective backlights; and a signal line transmitting control signals.

For example, Japanese Patent Application Laid-Open No. 2007-165336 discloses a configuration of a backlight drive device in which a plurality of backlight units and a drive control unit are wired by a daisy chain scheme. In the configuration of this conventional example, each backlight unit is provided with an amount-of-light detection means, and data units on the amounts of light from the backlight units detected by the respective amount-of-light detection means are sent to the drive control unit.

### PRIOR ART DOCUMENTS

### Patent Documents

[Patent Document 1] Japanese Patent Application Laid-Open No. 2007-165336

### SUMMARY OF THE INVENTION

### Problems to be Solved by the Invention

Here, in the above-described conventional backlight drive device, in order to identify from which backlight unit the data on the amount of light is sent to the drive control unit, a predetermined unique address is set for each backlight unit. Therefore, if one of the backlight units fails, then repairs are difficult and require cost.

When the configuration is such that a DIP switch or the like is provided so that the above-described addresses can be arbitrarily set manually, the commonization of the backlight units can be achieved. However, upon replacement, address setting work is required and thus repairs require time and effort and also setting errors are likely to occur.

An object of the present invention is therefore to provide a backlight drive device including a plurality of backlight units for which unique addresses are automatically set with a simple configuration, and a display device having the backlight drive device.

### Solution to the Problems

A first aspect of the present invention provides a backlight drive device that controls a luminance of a backlight including a plurality of light sources; the backlight drive device including:

a plurality of drive units, each controlling a luminance of one or more of the plurality of light sources and including a detector or a storage unit, the detector detecting one or more physical quantities related to the luminance of the one or more light sources, the physical quantities including an amount of light and an ambient temperature of the one or more light sources, and the storage unit storing predetermined inherent information related to the luminance of the one or more light sources;

a housing having the plurality of drive units mounted at their respective predetermined locations;

a control unit that receives a physical quantity detected by any of the detectors or inherent information stored in any of the storage units and controls, based on the received physical quantity or inherent information, a luminance of a corresponding light source; and

a bus signal line that transmits a signal indicating the physical quantity or the inherent information and that connects the plurality of drive units to the control unit by a bus scheme, wherein

each of the plurality of drive units includes a plurality of address setting terminals that can set a unique address in bit units by any one of two different predetermined potentials being provided thereto,

the housing includes connecting portions that are electrically connected, when each of the plurality of drive units is mounted at its predetermined location, to corresponding address setting terminals, and thereby provide any one of the predetermined potentials, a number of the connecting portions being less than or equal to a number of the corresponding address setting terminals, and the connecting portions being formed such that address setting terminals to be connected differ between the plurality of drive units, and

the control unit receives, via the bus signal line, a signal from any of the plurality of drive units identified by the unique address, the signal indicating the physical quantity or the inherent information.

According to a second aspect of the present invention, in the first aspect of the present invention,

any one of the predetermined potentials is provided to the housing, and

the connecting portions are conductive structures electrically connected to the housing.

According to a third aspect of the present invention, in the second aspect of the present invention,

the structures are protrusions formed such that by mounting each of the plurality of drive units at its predetermined location, corresponding protrusions come into contact with corresponding address setting terminals.

According to a fourth aspect of the present invention, in the second aspect of the present invention,

the structures are female screw portions that allow male screws to be screwed thereinto and that are electrically connected to corresponding address setting terminals by the male screws being screwed thereinto, the male screws fastening the address setting terminals.

According to a fifth aspect of the present invention, in the first aspect of the present invention,

each of the plurality of drive units includes a plurality of detectors that detect different types of physical quantities,

each of the plurality of detectors creates different unique address by adding a different value to an address set by potentials provided to a plurality of address setting terminals included in the drive unit including the plurality of detectors, and

the control unit receives, via the bus signal line, a signal from any of the plurality of detectors identified by the unique address, the signal indicating the physical quantity.

According to a sixth aspect of the present invention, in the fifth aspect of the present invention,

each of the plurality of detectors includes an A/D converter that converts a detected physical quantity into digital data, and

the value to be added to the address is fixedly preset for the A/D converter, the value being common to A/D converters of a same type included in other drive units and being different from a value for an other A/D converter included in the same drive unit.

According to a seventh aspect of the present invention, in the sixth aspect of the present invention,

the plurality of detectors include a first detector and a second detector, the first detector detecting an amount of light from one or more light sources and the second detector detecting an ambient temperature, and

the A/D converters included in the first and second detectors each have an input terminal that can set all or a part of an address to be created, and any one of a ground potential and a power supply potential is fixedly provided to the input terminal of one of the A/D converters such that the input terminal has a different potential than the input terminal of an other A/D converter.

According to an eighth aspect of the present invention, in the first aspect of the present invention,

the control unit performs communication with the plurality of drive units via the bus signal line by an IIC bus scheme.

A ninth aspect of the present invention provides a display device, including:

a backlight drive device according to the first aspect of the present invention; and

a display panel that displays an image based on video data provided from an external source.

### Effects of the Invention

According to the first aspect of the present invention, by electrically connecting a plurality of address setting terminals included in each of a plurality of drive units to corresponding connecting portions provided on a housing, unique addresses are assigned to the respective plurality of drive units, enabling to receive, from any of the plurality of drive units via a bus signal line, a signal indicating physical quantities such as temperature and the amount of light or inherent information indicating, for example, characteristic values such as temperature characteristics and degradation characteristics unique to the light sources. Accordingly, communication via a bus can be performed without presetting fixed addresses and thus the commonization of backlight drive units can be achieved.

According to the second aspect of the present invention, by means of conductive structures of predetermined potentials, unique addresses can be easily assigned to the respective plurality of drive units when the plurality of drive units are mounted at their respective predetermined locations.

According to the third aspect of the present invention, unique addresses can be easily assigned to the respective plurality of drive units, with a simple configuration in which protrusions are formed as the structures.

According to the fourth aspect of the present invention, unique addresses can be easily assigned to the respective plurality of drive units, with a simple configuration in which male screws and female screws that can fasten address setting terminals are used as the structures.

According to the fifth aspect of the present invention, since a plurality of detectors create different addresses by adding different values to an address set for a corresponding drive unit, an address for all of the detectors can be easily set only by assigning one address to the drive unit.

According to the sixth aspect of the present invention, each A/D converter is fixedly preset with a value to be added to an address, the value being common to A/D converters of the same type included in other drive units and being different from a value for the other A/D converter included in the same drive unit. Thus, the addresses of all of the A/D converters can be easily set only by assigning one address to one drive unit.

According to the seventh aspect of the present invention, the addresses of A/D converters included in first and second detectors can be set with a simple configuration.

According to the eighth aspect of the present invention, by adopting an IIC bus scheme which is a widely used bus connection scheme, the device configuration can be simplified, enabling to reduce manufacturing cost.

According to the ninth aspect of the present invention, as with the effect provided by the first aspect of the present invention, a display device can achieve the commonization of a backlight device.

### BRIEF DESCRIPTION OF THE DRAWINGS

FIG. 1 is a block diagram showing a configuration of a liquid crystal display device according to an embodiment of the present invention.

FIG. 2 is a diagram showing a detail of a backlight included in the liquid crystal display device according to the embodiment.

FIG. 3 is a block diagram showing a configuration of the backlight included in the liquid crystal display device according to the embodiment.

FIG. 4 is a block diagram showing a detailed configuration of backlight drive units in the embodiment.

FIG. 5 is a perspective view for describing a connection structure between a backlight housing and backlight drive units in the embodiment.

FIG. 6 is a diagram for describing a contact relationship between metal protrusions and metal pads in the embodiment.

FIG. 7 is a diagram describing a configuration implementing an electrical connection relationship by a screw fastening structure in the embodiment.

FIG. 8 is a block diagram showing a detailed configuration of backlight drive units in a variant of the embodiment.

### MODE FOR CARRYING OUT THE INVENTION

An embodiment of the present invention will be described below with reference to the accompanying drawings.

### <1. Overall Configuration and Overview of Operation>

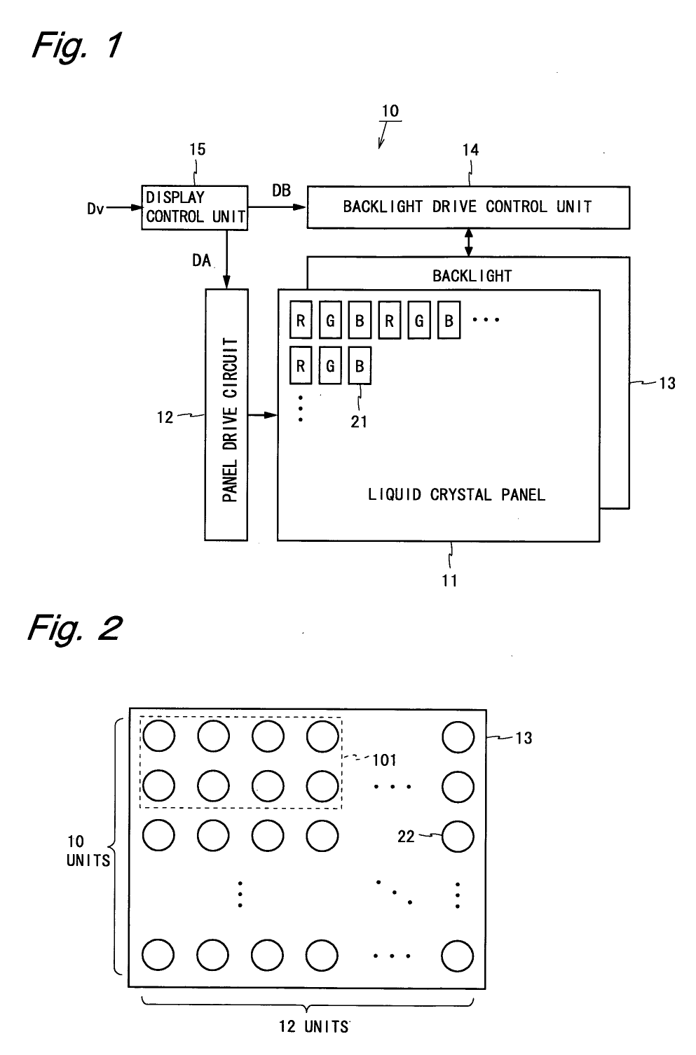

FIG. 1 is a block diagram showing a configuration of a liquid crystal display device 10 according to an embodiment of the present invention. The liquid crystal display device 10 shown in FIG. 1 includes a liquid crystal panel 11, a panel drive circuit 12, a backlight 13, a backlight drive control unit 14, and a display control unit 15. The liquid crystal display device 10 drives the liquid crystal panel 11 and controls the luminances of a plurality of light sources included in the backlight 13.

The liquid crystal panel 11 includes (m×n×3) display elements 21. The display elements 21 as a whole are arranged two-dimensionally, with 3 m display elements 21 in a row direction (a horizontal direction in FIG. 1) and n display elements 21 in a column direction (a vertical direction in FIG. 1). The display elements 21 include R display elements that allow red light in white light to be transmitted therethrough, G display elements that allow green light in white light to be transmitted therethrough, and B display elements that allow blue light in white light to be transmitted therethrough. The R display elements, the G display elements, and the B display elements are arranged side by side in the row direction, and three R, G, and B display elements form one pixel.

The panel drive circuit 12 is a drive circuit for the liquid crystal panel 11. The panel drive circuit 12 outputs signals (voltage signals) for controlling the light transmittances of the display elements 21 to the liquid crystal panel 11, based on liquid crystal data DA outputted from the display control unit 15. The voltages outputted from the panel drive circuit 12 are written into pixel electrodes (not shown) in the respective display elements 21, and the light transmittances of the display elements 21 change according to the voltages written into the respective pixel electrodes.

The backlight 13 is provided on the back side of the liquid crystal panel 11 and irradiates backlight light to the back of the liquid crystal panel 11. FIG. 2 is a diagram showing a detail of the backlight 13. As shown in FIG. 2, the backlight 13 includes 10×12 white LEDs 22. The white LEDs 22 as a whole are arranged two-dimensionally such that 12 white LEDs 22 are provided in the row direction and 10 white LEDs 22 are provided in the column direction. These white LEDs 22 are driven in a set of eight by a backlight drive unit. In FIG. 2, a total of eight white LEDs 22 present at the upper left, including four in the row direction and two in the column direction, are driven by a backlight drive unit 101 indicated by a dotted line. Each backlight drive unit includes an amount-of-light detector that detects the amount of light from corresponding white LEDs 22; and a temperature detector that detects an ambient temperature. The backlight drive units will be described in detail later. Lights emitted from the white LEDs 22 hit a part of the back of the liquid crystal panel 11.

The backlight drive control unit 14 is a circuit for controlling the drive of the backlight 13. The backlight drive control unit 14 outputs signals for controlling the luminances of all of the white LEDs 22 to the backlight drive units, based on LED data DB outputted from the display control unit 15 and the amounts of light and ambient temperatures of the white LEDs 22 which will be described later. The luminance of each LED 22 is controlled independently of the luminances of other LEDs 22 inside and outside its corresponding unit.

The display control unit 15 outputs LED data DB representing the luminances of all of the white LEDs 22 included in the backlight 13, to the backlight drive control unit 14 based on a display mode being set and image data Dv. In addition, the display control unit 15 determines, based on the image data Dv, light transmittances of all of the display elements 21 included in the liquid crystal panel 11 and outputs liquid crystal data DA representing the determined light transmittances to the panel drive circuit 12.

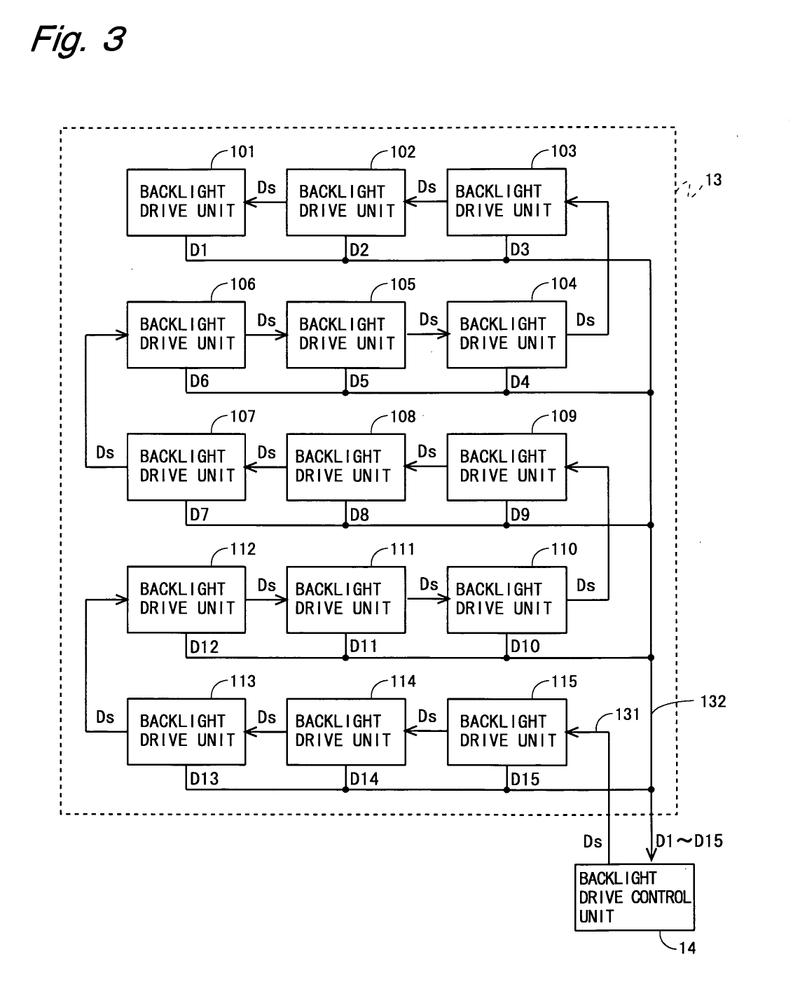

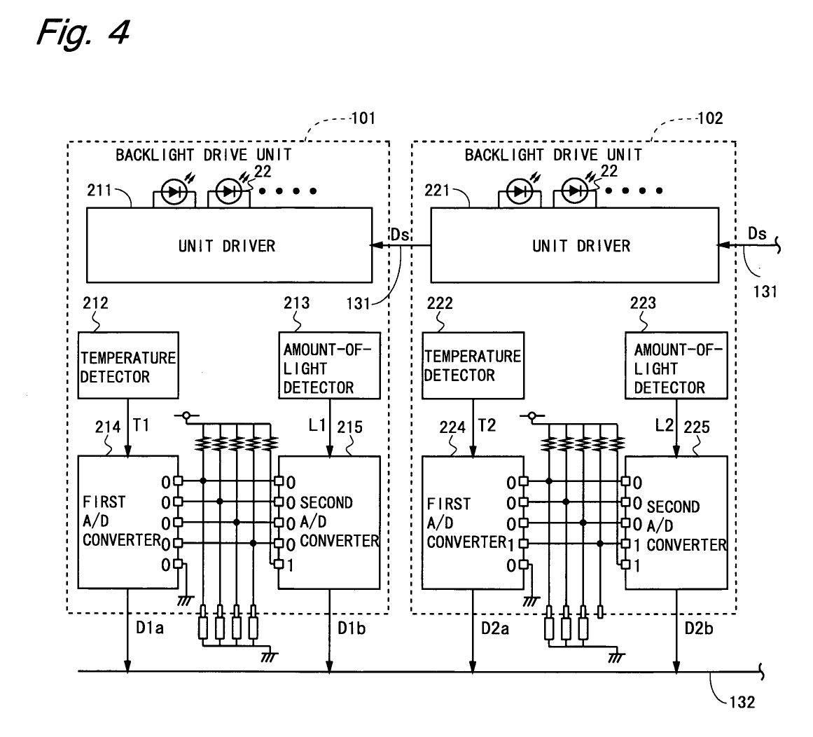

According to the liquid crystal display device 10 configured in the above-described manner, by obtaining suitable liquid crystal data DA and LED data DB based on image data Dv and controlling the light transmittances of the display elements 21 based on the liquid crystal data DA, the image data Dv can be displayed on the liquid crystal panel 11. Next, with reference to FIGS. 3 and 4, the configurations and operations of the backlight and the backlight drive units composing the backlight will be described.

### <2. Configurations and Operations of the Backlight and the Backlight Drive Units>

### <2.1 Overall Configurations of the Backlight and the Backlight Drive Units>

FIG. 3 is a block diagram showing a configuration of the backlight 13 in the present embodiment. The backlight 13 is, as described above, composed of 15 backlight drive units 101 to 115 that control the 120 white LEDs 22. The backlight drive units 101 to 115 all have the same configuration except the connection relationship with a signal line. A detailed configuration thereof will be described later using FIG. 4.

As shown in FIG. 3, the backlight drive units 101 to 115 are connected to the backlight drive control unit 14 by a serial signal line 131 which transmits real data and an IIC (Inter Integrated Circuit) bus 132 which is a bus standard proposed by Royal Philips Electronics Inc. Note that the IIC bus is also written as an I²C bus.

The serial signal line 131 connects from the backlight drive control unit 14 to the backlight drive units 101 to 115 one by one in turn. Specifically, the serial signal line 131 connects the badklight drive control unit 14 to the backlight drive unit 115, connects the backlight drive unit 115 to the next backlight drive unit 114, and connects the backlight drive unit 114 to the next backlight drive unit 113. As such, the serial signal line 131 connects all the way to the backlight drive unit 101 in turn by a so-called daisy chain scheme. The backlight drive control unit 14 transmits, upon initial operation, a signal for assigning an address (hereinafter, referred to as a “serial address”) to each of the backlight drive units 101 to 115 in turn, and thereafter transmits, upon normal operation, a luminance data signal Ds for controlling the luminances of white LEDs 22 included to each of the backlight drive units 101 to 115 in turn.

The IIC bus 132 directly connects the backlight drive control unit 14 to each of the backlight drive units 101 to 115 by a so-called bus scheme. When a communication state is established, each of the backlight drive units 101 to 115 transmits one of digital data units D1 to D15 corresponding to the amount of light and temperature detected by an amount-of-light detector and a temperature detector included in the unit, to the backlight drive control unit 14 via the IIC bus 132. Note that addresses used for communication by the above-described bus scheme are hereinafter referred to as “bus addresses” and are distinguished from the above-described serial addresses.

FIG. 4 is a diagram showing a detailed configuration of the backlight drive units 101 and 102. As shown in this FIG. 4, the backlight drive unit 101 includes eight white LEDs 22; a unit driver 211 that drives the white LEDs 22; a temperature detector 212 that detects a temperature of the white LEDs 22 included in the backlight drive unit 101; a first A/D converter 214 that converts analog data T1 representing the detected temperature into digital data; an amount-of-light detector 213 that detects an amount of light from the white LEDs 22; and a second A/D converter 215 that converts analog data L1 representing the detected amount of light into digital data.

The backlight drive unit 102 also has the same components as the backlight drive unit 101, and includes eight white LEDs 22; a unit driver 221; a temperature detector 222; a first A/D converter 224 that converts analog data T2 representing a temperature into digital data; an amount-of-light detector 223; and a second A/D converter 225 that converts analog data L2 representing a detected amount of light into digital data. Note, however, that serial addresses set for the backlight drive unit 101 and the backlight drive unit 102 differ from each other. Since all other backlight drive units 103 to 115 also have exactly the same components, the following specifically describes only the configuration of the backlight drive unit 101.

When a serial address (here, 4 bits) included in a luminance data signal Ds transmitted from the backlight drive control unit 14 specifies the address of a unit where the unit driver 211 is included, the unit driver 211 allows the white LEDs 22 to emit light at appropriate luminances based on the luminance data signal Ds destined for the unit which is transmitted from the backlight drive control unit 14.

Here, as will be described below, bus addresses are also set for the first and second A/D converters 214 and 215, too, but the bus addresses are used to perform communication via the IIC bus 132 and thus are set independently of the serial address assigned to the unit driver 211. Therefore, these address values may be different or may be the same.

As shown in FIG. 4, each of the first and second A/D converters 214 and 215 includes five address input terminals represented by squares. Of the address input terminals, four associated pairs of address input terminals are connected to each other and are connected to a power supply potential through pull-up resistors. These address input terminals are also connected to metal pads 301a to 301d which will be described later. The metal pads 301a to 301d, in some cases, come into contact with metal protrusions 401a to 401d which will be described later, and are thereby connected to a ground potential. In that case, these address input terminals are brought to the ground potential.

For the remaining one address input terminal, one included in the first A/D converter 214 is connected to the ground potential, and one included in the second A/D converter 215 is connected to the power supply potential. Here, the bit value “0” is provided to an address input terminal connected to the ground potential and the bit value “1” is provided to an address input terminal connected to the power supply potential. As such, by fixedly setting a part of a bus address such that A/D converters in the same backlight drive unit are distinguished from each other, the bus addresses of all of the A/D converters do not need to be individually set and thus the configuration can be simplified. In addition, only by assigning one bus address to one backlight drive unit, the bus addresses of all of the A/D converters can be set easily.

### <2.2 Setting of a Bus Address of a Backlight Drive Unit>

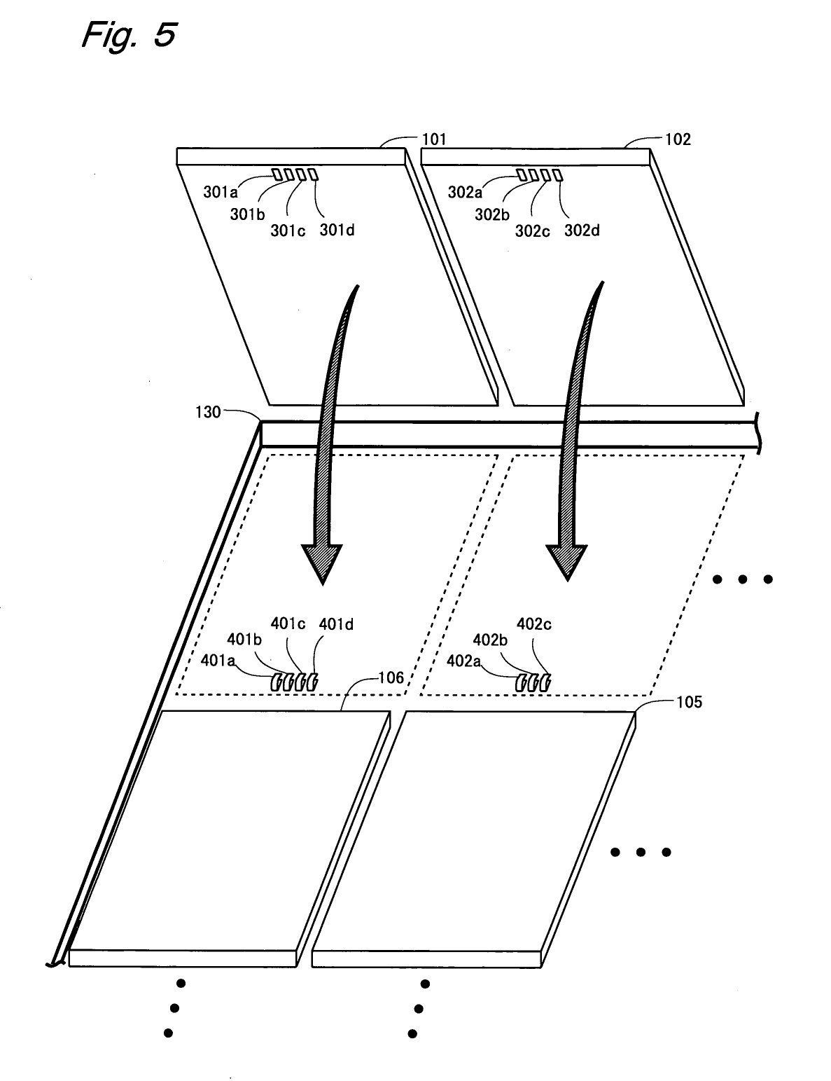

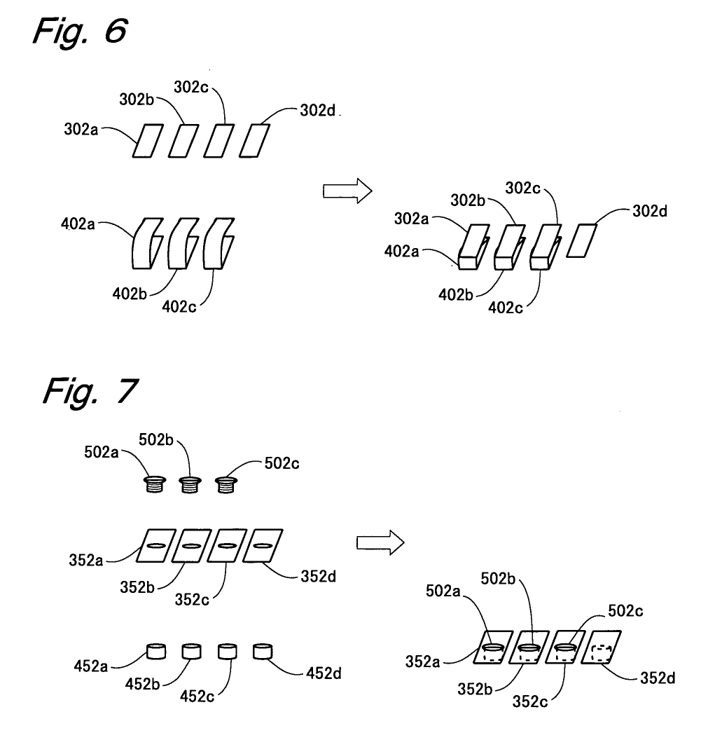

Next, a technique for setting a bus address of a backlight drive unit in the present embodiment will be described with reference to FIGS. 5 and 6.

FIG. 5 is a perspective view for describing a connection structure between a backlight housing and backlight drive units. A backlight housing 130 shown in FIG. 5 is a housing for mounting the aforementioned backlight drive units 101 to 115. Here, for description's sake, the drawing shows a state in which the backlight drive units 105 and 106 are already mounted and the backlight drive units 101 and 102 are about to be mounted.

Note that the form and size of the backlight drive units 101 to 115 differ from the actual ones but are simply shown for description's sake. Note also that, although the serial signal line 131, the IIC bus 132, a power supply wiring, various locking members (including a grounding screw, etc.), and the like, are mounted on the backlight housing in practice, description thereof is omitted for convenience of description.

As shown in FIG. 5, metal pads 301a to 301d and 302a to 302d are provided on the undersides of the backlight drive units 101 and 102 (sides facing the backlight housing 130). The metal pads 301a to 301d and 302a to 302d are, as described above, connected to their respective corresponding address input terminals of the first and second A/D converters 214, 215, 224, and 225, and they integrally function as address setting terminals.

In addition, as shown in FIG. 5, metal protrusions 401a to 401d are provided at locations with which the metal pads 301a to 301d just come into contact when the backlight drive unit 101 is mounted. The metal protrusions 401a to 401d are metal members which are a part of the backlight housing 130 which is metal, or metal members mounted so as to be electrically connected to the backlight housing 130. Since the backlight housing 130 is set to the ground potential, the metal protrusions 401a to 401d have the same ground potential. Therefore, only by mounting the backlight drive unit 101 on the backlight housing 130, the metal pads 301a to 301d (automatically) come into contact with the metal protrusions 401a to 401d, and thus, the potentials of the metal pads 301a to 301d can be easily set to the ground potential.

Note that by setting the backlight housing 130 to the power supply potential or by electrically disconnecting the metal protrusions 401a to 401d from the backlight housing 130 and setting the metal protrusions 401a to 401d to the power supply potential, the potentials of the metal pads 301a to 301d can also be set to the power supply potential.

The metal protrusions 401a to 401d can be any as long as passage of current between the metal protrusions 401a to 401d and the metal pads 301a to 301d can be accomplished only by mounting the backlight drive unit 101 on the backlight housing 130. For example, the metal protrusions 401a to 401d may be protruding structures made of a conductive material other than a metal (or coated with a conductive material).

A structure such as that described above is also the same for when mounting the backlight drive unit 102, and is the same in terms of that metal protrusions 402a to 402c are provided at locations with which the metal pads 302a to 302c just come into contact when the backlight drive unit 102 is mounted. However, as can be seen by referring to FIGS. 5 and 6, there is no metal protrusion to come into contact with the metal pad 302d.

FIG. 6 is a diagram for describing a contact relationship between metal pads and metal protrusions. As shown on the left side of FIG. 6, there is no metal protrusion for the metal pad 302d. Hence, as shown on the right side of FIG. 6, even when the metal protrusions 402a to 402c go into a state of being in contact with the metal pads 302a to 302c by mounting the backlight drive unit 102, the metal pad 302d is not electrically connected to the backlight housing 130. Hence, the potentials of corresponding address input terminals of the first and second A/D converters 224 and 225 remain pulled up to the power supply potential. Therefore, as shown in FIG. 4, the upper 4 bits of the bus addresses of the first and second A/D converters 224 and 225 are set to “0001”. Note that the point that the value of the least significant bit of the bus address of the first A/D converter 224 is fixedly set to “0” and the value of the least significant bit of the bus address of the second A/D converter 225 is fixedly set to “1” is as described above.

In addition, though not shown, for electrode pads included in the backlight drive units 103 to 115, too, by likewise providing or not providing metal protrusions at their respective corresponding locations of the backlight housing 130, any bus address can be set.

Note that the metal protrusions are an example of a structure implementing an electrical connection with the backlight housing 130 and thus various types of forms, configurations, etc., are considered for the metal protrusions. For example, the configuration may be such that metal protrusions are provided for all metal pads and in order that a metal protrusion does not come into contact with a metal pad that is not to be set to the ground potential, the height of the metal protrusion is reduced or an insulating material is sandwiched or applied to a surface of the metal protrusion.

Note also that an electrical connection structure different than the metal protrusions 401a to 401d may be provided. For example, known techniques are considered such as connection by a metal spring, a conductive brush, etc., and screw fastening. Now, an example of a screw fastening structure will be described in detail with reference to FIG. 7.

FIG. 7 is a diagram describing a configuration implementing an electrical connection relationship by a screw fastening structure. As shown on the left side of FIG. 7, wiring regions 352a to 352d connected to the above-described four address input terminals of each of the first and second A/D converters 224 and 225 are provided on the front side of the backlight drive unit 102 (a side opposite to the side facing the backlight housing 130). The wiring regions 352a to 352d are provided with openings into which metal screws 502a to 502c can be inserted. Note, however, that as shown in the drawing, a metal screw is not inserted into the opening of the wiring region 352d.

In addition, female screw portions 452a to 452d made of metal which allow the metal screws 502a to 502c, male screws, to be screwed thereinto are formed or mounted at corresponding locations of the backlight housing 130. They are metal members which are a part of the backlight housing 130 or metal members mounted so as to be electrically connected to the backlight housing 130. Since the backlight housing 130 is set to the ground potential, they have the same ground potential.

Therefore, as shown on the left side of FIG. 7, by mounting the backlight drive unit 102 and inserting the metal screws 502a to 502c into the openings to screw the metal screws 502a to 502c into the female screw portions 452a to 452c, the heads of the metal screws 502a to 502c and the wiring regions 352a to 352c are electrically connected to each other and can be thereby brought to the ground potential. As a result, likewise, the upper 4 bits of the bus addresses of the first and second A/D converters 224 and 225 are set to “0001”.

Note that according to the above-described configuration, any bus address can be set by appropriately selecting locations where screws are fastened; however, if screw fastening is done at a wrong location, then a correct bus address cannot be set. To prevent such erroneous setting from being performed, a configuration in which the female screw portion 452d is omitted is preferable. In addition, in this case, a configuration is also considered in which in order that a metal screw inserted erroneously does not come into contact with the backlight housing 130 or that a metal screw is not inserted erroneously, an insulative structure is provided instead of the female screw portion 452d.

By a structure such as that described above, only by a simple process of mounting the backlight drive units 101 to 115 on the backlight housing 130, the bus addresses (of the A/D converters) of the respective units can be automatically set. Next, specific content of IIC communication using bus addresses set in the above-described manner will be described in more detail.

The first and second A/D converters 214 and 215 each create a unique 7-bit address for performing communication through the IIC bus 132, by assigning the predetermined device identification bits “01” to the upper bits of a bit string specified by the address input terminals. Specifically, the address values of the first and second A/D converters 214 and 215 are “0100000” and “0100001”, respectively. Now, procedural steps for communication performed with the backlight drive control unit 14 via the IIC bus 132 will be described using the first A/D converter 214 as an example.

The IIC bus 132 is composed of two lines, a serial clock line and a serial data line. Communication is performed such that while synchronization is achieved by a serial clock SCL transmitted through the serial clock line, serial data SDA is transmitted through the serial data line. Specifically, the backlight drive control unit 14 waits for the IIC bus 132 to be released and issues a start condition, and transmits bit data including a 7-bit slave address (e.g., “0100000”) assigned to an A/D converter from which data needs to be obtained (e.g., the first A/D converter 214) and the 1-bit least significant bit representing a transmission/reception direction. The A/D converter having the slave address transmits digital data (here, digital data D1a corresponding to analog data T1 representing temperature) as serial data SDA, and the backlight drive control unit 14 receives the data. When the communication is completed thereafter and the bus is released, the backlight drive control unit 14 issues a stop condition. By performing communication such as that described above with each A/D converter (e.g., by receiving digital data Dib from the second A/D converter 215, digital data D2a from the first A/D converter 224, digital data D2b from the second A/D converter 225, etc.), the backlight drive control unit 14 obtains data on the amounts of light and ambient temperatures for all of the backlight drive units 101 to 115.

As described above, of a 7-bit slave address unique to each A/D converter, in order to set 4 bits of 5 bits, excluding the upper 2 bits common to all, address input terminals of first and second A/D converters are connected to metal protrusions of the backlight housing 130, and in order to set the remaining 1 bit of the 5 bits, a corresponding address input terminal of the first A/D converter is connected to the ground potential and a corresponding address input terminal of the second A/D converter is connected to the power supply potential. By such a configuration, while the configurations of the backlight drive units 101 to 115 are commonized, only by setting a unique address (here, 4 bits) to each of the backlight drive units 101 to 115, unique slave addresses (here, 7 bits) can be set for all A/D converters. Therefore, even if any of the backlight drive units 101 to 115 fails, it is only necessary to replace the failed backlight drive unit with a new backlight drive unit having the same components (without performing any special setting work, etc.), and thus, the time and effort and cost required for repairs can be reduced.

### <4. Effects>

As described above, according to the present embodiment, for electrode pads included in the backlight drive units 103 to 115, by providing or not providing metal protrusions at corresponding locations of the backlight housing 130, any bus address can be set. Therefore, without presetting a fixed address for each unit, communication through the IIC bus 132 can be performed. As such, in the backlight drive device, since unique addresses can be automatically set with a simple configuration, the commonization of backlight drive units can be achieved. In addition, upon replacement, address setting work is not required and thus repairs do not require time and effort and the occurrence of setting errors can be prevented.

### <5. Others>

Although, in the above-described embodiment, the IIC bus 132 performing communication based on unique addresses set by metal protrusions, etc., of the backlight housing 130 is used, instead of the IIC bus 132, a signal line that connects the backlight drive units 101 to 115 by a bus connection scheme using addresses, such as an SPI (Serial Peripheral Interface) or an SMBus (System Management Bus), may be used. In addition, instead of the serial signal line 131 transmitting luminance data, a signal line that connects the backlight drive units 101 to 115 by other daisy chain schemes may be used, or the serial signal line 131 may be omitted and luminance data may be transmitted using the IIC bus 132 or a signal line of other bus connection schemes.

In the above-described embodiment, the configuration is such that of a unique 7-bit slave address, in order to set 4 bits of 5 bits, excluding the upper 2 bits common to all, address input terminals of first and second A/D converters are connected to metal protrusions of the backlight housing 130, and in order to set the remaining 1 bit, a corresponding address input terminal of the first A/D converter is connected to the ground potential and a corresponding address input terminal of the second A/D converter is connected to the power supply potential; however, all of the 5 bits may be set by metal protrusions of the backlight housing 130. In addition, the addresses of first and second A/D converters included in the same unit may be individually set (without commonizing the upper 4 bits). In this case, eight or ten metal protrusions are required per unit.

By using first and second A/D converters whose unique slave addresses are preset to differ from each other in part (e.g., a device identification address, etc.) due to different types (e.g., manufacturers), there is no need to connect a corresponding address input terminal to the ground potential or the power supply potential to set the remaining 1 bit, and it is only necessary to set the 4 bits by metal protrusions of the backlight housing 130.

Furthermore, the slave addresses may be composed of unique 10 bits defined by the IIC standard. In this case, since a unique address can be set with 8 bits, excluding the upper 2 bits common to all, for example, 256 backlight drive units can be connected.

Although in the above-described embodiment the backlight 13 uses the white LEDs 22 as light sources, instead of this or together with this, light sources where red, green, and blue LEDs are combined may be used, or instead of them or together with them, CCFLs (Cold Cathode Fluorescent Lamps) may be used as light sources. In addition, although the liquid crystal panel 11 is composed of multiple display elements 21 including a liquid crystal, shutter elements may be used which are made of a known material having electro-optical characteristics capable of control the transmittance of light from the backlight 13, instead of a liquid crystal.

In the above-described embodiment, the 15 backlight drive units 101 to 115 each include eight white LEDs 22, but the numbers of backlight drive units 101 to 115 and white LEDs 22 are examples and thus there are no particular limitations on those numbers.

Although, in the above-described embodiment, one temperature detector and one amount-of-light detector are included in each of the backlight drive units 101 to 115 and two A/D converters for the respective detectors are included, there are no limitations on the number and type of detectors. For example, a configuration in which only one of a temperature detector and an amount-of-light detector is included, or a configuration in which one or both of them are included in plural number, or a configuration in which a current detector, a voltage detector, or the like, is included may be used.

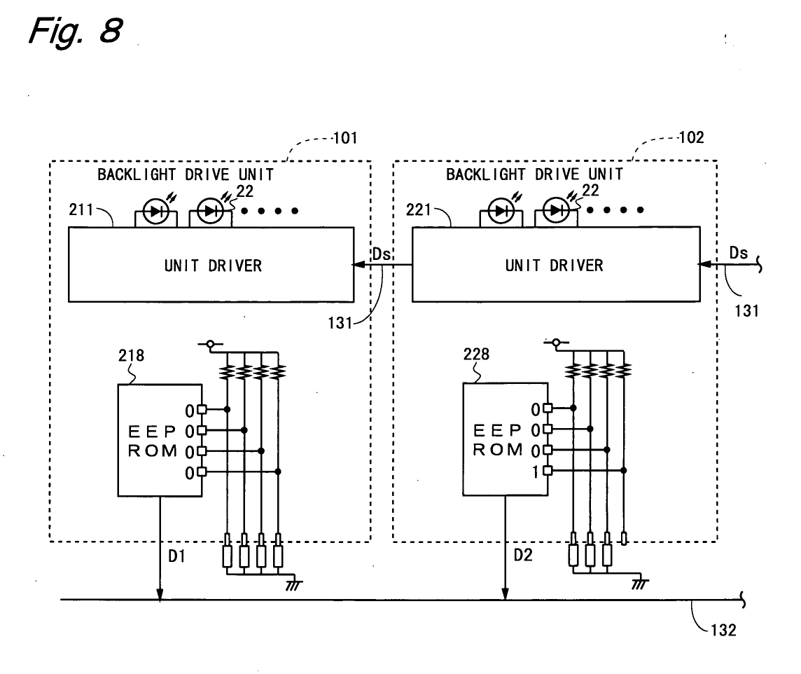

The configuration may be such that, instead of the above-described detectors, a storage unit that outputs predetermined inherent information is included, e.g., typically, a semiconductor memory such as an EEPROM (Electrically Erasable and Programmable Read Only Memory). Inherent information stored in the storage unit is information related to the luminances of white LEDs included in the same backlight drive unit, and is typically data representing characteristic values such as temperature characteristics and degradation characteristics unique to the white LEDs. Such a configuration will be described with reference to FIG. 8.

FIG. 8 is a diagram showing a detailed configuration of backlight drive units 101 and 102 including an EEPROM in a variant of the embodiment. The backlight drive unit 101 shown in this FIG. 8 includes eight white LEDs 22 and a unit driver 211 that drives the white LEDs 22, which are the same as those included in a backlight drive unit 101 shown in FIG. 4, and includes an EEPROM 218 that stores inherent information indicating characteristic values such as temperature characteristics and degradation characteristics unique to the white LEDs 22 included in the backlight drive unit 101, instead of a temperature detector 212, an amount-of-light detector 213, a first A/D converter 214, and a second A/D converter 215.

The backlight drive unit 102 also has the same components as the backlight drive unit 101, and includes eight white LEDs 22 and a unit driver 221 and includes an EEPROM 228 that stores the above-described inherent information unique to the white LEDs 22 included in the backlight drive unit 102.

These pieces of inherent information are typically obtained by measuring characteristic values such as temperature characteristics and degradation characteristics unique to white LEDs 22 included in a corresponding backlight drive unit, by a known measuring device upon manufacturing the device (or upon repairing, etc.). The obtained pieces of inherent information are written into a corresponding EEPROM by a known EEPROM writer, etc.

Now, the backlight drive unit 101 will be described. As shown in FIG. 8, the EEPROM 218 includes four address input terminals represented by squares. The address input terminals are connected to a power supply potential through pull-up resistors and are also connected to the aforementioned metal pads 301a to 301d. The metal pads 301a to 301d may be connected to a ground potential by coming into contact with metal protrusions 401a to 401d. In that case, these address input terminals are brought to the ground potential. When the metal pads 301a to 301d do not come into contact with the metal protrusions 401a to 401d, the potentials of corresponding address input terminals remain pulled up to the power supply potential. Therefore, as shown in FIG. 8, the bus address of the EEPROM 218 (here, the bus address is assumed to have 4 bits) is set to “0000” and the bus address of the EEPROM 228 is set to “0001”. As such, as with the above-described embodiment, by providing or not providing metal protrusions at corresponding locations of a backlight housing 130, a unique bus address can be arbitrarily set for each of the backlight drive units 101 to 115.

Note that an EEPROM for which a unique bus address is thus set performs communication with a backlight drive control unit 14 via an IIC bus 132, and procedural steps for the communication are as described above. The backlight drive control unit 14 transmits bit data including a 7-bit slave address (e.g., “0100000”) assigned to an EEPROM from which inherent information needs to be obtained (e.g., the EEPROM 218) and the 1-bit least significant bit representing a transmission/reception direction, to the IIC bus 132 and receives digital data including the inherent information (e.g., digital data D1) from the EEPROM (e.g., the EEPROM 218). By this, the backlight drive control unit 14 obtains data representing characteristic values such as temperature characteristics and degradation characteristics unique to the LEDs in all of the backlight drive units 101 to 115. As such, without presetting a fixed address for each unit, communication through the IIC bus 132 can be performed. Thus, for example, when a given backlight drive unit fails, it is only necessary to replace the failed unit with a new backlight drive unit different than the failed unit that has the same components and includes an EEPROM storing information unique to the failed unit (without performing any special setting work, etc.). Hence, the time and effort and cost required for repairs can be reduced.

Note that the backlight drive control unit 14 in the variant temporarily stores pieces of inherent information obtained from all of the backlight drive units 101 to 115 and determines luminance data representing the light emission intensities of the respective LEDs, based on the pieces of stored inherent information (and temperature information from temperature sensors which are not shown, etc.). This also applies to the above-described embodiment. In addition, communication through the IIC bus 132 in the variant does not need to be performed many times with appropriate intervals provided during the operation of the device, like a typical exemplary operation in the above-described embodiment, and it is only necessary to perform communication only once upon activating the device or upon replacing a unit.

Although, in the above-described embodiment, the configuration is such that the luminances of backlights are individually controlled so as to uniformly illuminate a display area, the configuration may be such that the luminances of backlights are individually controlled in a display device adopting a so-called area active drive scheme. The area active drive scheme is a method in which a screen is divided into a plurality of areas and while controlling, based on an input image in an area, the luminances of backlight light sources for the area, a display panel is driven. In an image display device having a backlight such as a liquid crystal display device, by controlling the luminance of the backlight based on an input image, the power consumption of the backlight can be suppressed and the image quality of a displayed image can be improved. In an image display device performing the area active drive, for the luminances of LEDs (the luminances upon light emission) for each area, appropriate luminances are determined based on the highest value and mean value of the luminances of pixels in the area, etc., and provided to a backlight drive control unit, as LED data. In addition, based on the LED data and an input image, display data (in the case of a liquid crystal display device, data for controlling the light transmittances of liquid crystals) is generated. The display data is provided to a display panel drive circuit. In the case of a liquid crystal display device, the luminance of each pixel on the screen is the product of the luminante of light from a backlight and a light transmittance based on the display data. The configuration may be such that the display panel drive circuit is driven based on the display data thus generated and the backlight is driven based on the LED data, whereby image display based on an input image is performed.

### INDUSTRIAL APPLICABILITY

The present invention is applied, for example, to a backlight drive device that drives a backlight illuminating a liquid crystal panel from the back and a display device having the backlight drive device, and is suitable for a backlight drive device having the function of controlling the luminances of a plurality of backlights (backlight dimming function) and a display device having the backlight drive device.

### DESCRIPTION OF REFERENCE NUMERALS

10: LIQUID CRYSTAL DISPLAY DEVICE

11: LIQUID CRYSTAL PANEL

12: PANEL DRIVE CIRCUIT

13: BACKLIGHT

14: BACKLIGHT DRIVE CONTROL UNIT

15: DISPLAY CONTROL UNIT

21: DISPLAY ELEMENT

22: LED

101 to 115: BACKLIGHT DRIVE UNIT

130: BACKLIGHT HOUSING

211 and 221: UNIT DRIVER

212 and 222: TEMPERATURE DETECTOR

213 and 223: AMOUNT-OF-LIGHT DETECTOR

214 and 224: FIRST A/D CONVERTER

215 and 225: SECOND A/D CONVERTER

218 and 228: EEPROM

301a to 301d and 302a to 302d: METAL PAD

352a to 352d: WIRING-REGION

401a to 401d and 402a to 402c: METAL PROTRUSION

452a to 452d: FEMALE SCREW PORTION

502a to 502c: METAL SCREW

D1 to D15: DIGITAL DATA

Ds: LUMINANCE DATA SIGNAL

DA: LIQUID CRYSTAL DATA

1. A backlight drive device that controls a luminance of a backlight including a plurality of light sources; the backlight drive device comprising:
a plurality of drive units, each controlling a luminance of one or more of the plurality of light sources and including a detector or a storage unit, the detector detecting one or more physical quantities related to the luminance of the one or more light sources, the physical quantities including an amount of light and an ambient temperature of the one or more light sources, and the storage unit storing predetermined inherent information related to the luminance of the one or more light sources;
a housing having the plurality of drive units mounted at their respective predetermined locations;
a control unit that receives a physical quantity detected by any of the detectors or inherent information stored in any of the storage units and controls, based on the received physical quantity or inherent information, a luminance of a corresponding light source; and
a bus signal line that transmits a signal indicating the physical quantity or the inherent information and that connects the plurality of drive units to the control unit by a bus scheme, wherein
each of the plurality of drive units includes a plurality of address setting terminals that can set a unique address in bit units by any one of two different predetermined potentials being provided thereto,
the housing includes connecting portions that are electrically connected, when each of the plurality of drive units is mounted at its predetermined location, to corresponding address setting terminals, and thereby provide any one of the predetermined potentials, a number of the connecting portions being less than or equal to a number of the corresponding address setting terminals, and the connecting portions being formed such that address setting terminals to be connected differ between the plurality of drive units, and
the control unit receives, via the bus signal line, a signal from any of the plurality of drive units identified by the unique address, the signal indicating the physical quantity or the inherent information.

2. The backlight drive device according to claim 1, wherein
any one of the predetermined potentials is provided to the housing, and the connecting portions are conductive structures electrically connected to the housing.

3. The backlight drive device according to claim 2, wherein the structures are protrusions formed such that by mounting each of the plurality of drive units at its predetermined location, corresponding protrusions come into contact with corresponding address setting terminals.

4. The backlight drive device according to claim 2, wherein the structures are female screw portions that allow male screws to be screwed thereinto and that are electrically connected to corresponding address setting terminals by the male screws being screwed thereinto, the male screws fastening the address setting terminals.

5. The backlight drive device according to claim 1, wherein
each of the plurality of drive units includes a plurality of detectors that detect different types of physical quantities,
each of the plurality of detectors creates different unique address by adding a different value to an address set by potentials provided to a plurality of address setting terminals included in the drive unit including the plurality of detectors, and the control unit receives, via the bus signal line, a signal from any of the plurality of detectors identified by the unique address, the signal indicating the physical quantity.

6. The backlight drive device according to claim 5, wherein
each of the plurality of detectors includes an A/D converter that converts a detected physical quantity into digital data, and
the value to be added to the address is fixedly preset for the A/D converter, the value being common to A/D converters of a same type included in other drive units and being different from a value for an other A/D converter included in the same drive unit.

7. The backlight drive device according to claim 6, wherein
the plurality of detectors include a first detector and a second detector, the first detector detecting an amount of light from one or more light sources and the second detector detecting an ambient temperature, and
the A/D converters included in the first and second detectors each have an input terminal that can set all or a part of an address to be created, and any one of a ground potential and a power supply potential is fixedly provided to the input terminal of one of the A/D converters such that the input terminal has a different potential than the input terminal of an other A/D converter.

8. The backlight drive device according to claim 1, wherein the control unit performs communication with the plurality of drive units via the bus signal line by an IIC bus scheme.

9. A display device comprising:
a backlight drive device according to claim 1; and
a display panel that displays an image based on video data provided from an external source.
